(19) United States
(12) Patent Application Publication
(10) Pub. No.: US 2024/0095553 A1
(43) Pub. Date: Mar. 21, 2024

(54) SYSTEMS AND METHODS FOR EVALUATING COUNTERFACTUAL SAMPLES FOR EXPLAINING MACHINE LEARNING MODELS

(71) Applicant: Capital One Services, LLC, McLean, VA (US)

(72) Inventor: Brian BARR, Schenectady, NY (US)

(73) Assignee: Capital One Services, LLC, McLean, VA (US)

(21) Appl. No.: 17/933,136

(22) Filed: Sep. 19, 2022

(51) Int. Cl. G06N 5/04; G06N 5/02

(52) U.S. Cl. CPC G06N 5/045; G06N 5/022

(57) ABSTRACT

In some aspects, a computing system may train a machine learning model to classify a plurality of samples of a training dataset. The computing system may generate a plurality of counterfactual samples. The computing system may determine a distance score between the training dataset and a first counterfactual sample of the plurality of counterfactual samples. Based on determining that the distance between the training dataset and the first counterfactual sample is smaller than other distances corresponding to other counterfactual samples of the plurality of counterfactual samples, the computing system may generate a recommendation to use the first counterfactual sample.

### BACKGROUND

Explainable artificial intelligence or machine learning includes a set of methods that allows human users to understand why certain results or output was generated by a machine learning model. Explainable machine learning may be used to explain a machine learning model's reasoning and characterize the strengths and weaknesses of the model's decision-making process. Explainable machine learning may be necessary to establish trust in the output generated by machine learning models. For example, for ethical reasons, legal reasons, and to increase trust, a doctor may need to understand why a machine learning model is recommending a particular procedure for a patient.

In explainable machine learning, counterfactual explanations can be used to explain machine learning model output corresponding to individual samples. In general, a machine learning model generates output (e.g., a classification) for a sample, and the particular feature values of the sample that were input to the model cause the output. For a counterfactual sample, the feature values of a sample are changed before inputting the sample into the machine learning model and the output changes in a relevant way. For example, the class output by the machine learning model for the counterfactual sample is opposite of the class output for the original sample. Alternatively, a counterfactual sample may cause the machine learning model to generate output that reaches a certain threshold (e.g., where the machine learning model outputs a probability that cancer is present reaches 10% or greater). A counterfactual sample of an original sample may try to minimize the amount of change to the feature values of the original sample while still changing the machine learning model's output.

### SUMMARY

Counterfactual samples can be used to explain why a machine learning model generated particular output because they are contrastive to a sample (e.g., the machine learning model generates a classification for the counterfactual sample that is opposite of the classification generated for the sample) and because a counterfactual sample is selective in that a counterfactual sample generally has a small number of feature changes compared to its corresponding sample. However, it is possible to have many counterfactual samples for a single sample, with each counterfactual sample indicating a different (e.g., contradictory) explanation for output of the machine learning model. It may be difficult to determine which counterfactual sample should be used to explain a result generated by the machine learning model. For example, one counterfactual sample may indicate that feature A should be changed to achieve a desired output while another counterfactual sample may indicate that feature A should be left the same and that feature B should be changed to achieve the desired output. Non-conventional methods and systems described herein may provide a criterion to evaluate counterfactuals and select one for use in explaining output of machine learning models.

Additionally, for a given counterfactual sample generation method, it can be important that the counterfactual sample that is generated remains representative of the training data set on which the machine learning model was trained. To achieve this objective, conventional systems may use computationally expensive techniques that involve training complex autoencoders on large datasets, modifying latent activations of the autoencoders, and using the modified latent activations to generate counterfactual samples. These conventional techniques may problematically include autoencoders that are difficult to train properly and require a great deal of computation power. Additionally, an autoencoder may need to be trained for each dataset separately, making the entire counterfactual sample generation process cumbersome.

To address these example problems among other potential problems, non-conventional methods and systems described herein may provide a mechanism for evaluating counterfactual samples and determining whether a counterfactual sample is representative of the training dataset, without the need to train additional complex machine learning models to generate the counterfactual samples. By providing the ability to evaluate different counterfactual samples, systems and methods described herein can use counterfactual samples generated using less computationally intensive techniques and eliminate the need to train complicated models such as autoencoders to generate the counterfactual samples. Specifically, methods and systems described herein determine a distance (e.g., a maximum mean discrepancy) between a training dataset and a counterfactual sample of a plurality of counterfactual samples. A recommendation to use the counterfactual sample may then be generated based on determining that the counterfactual sample's corresponding distance is smaller than other distances corresponding to the other counterfactual samples. The distance may indicate how close (e.g., representative) the counterfactual sample is to the training dataset. The ability to compare counterfactual samples may enable a computing system to determine which counterfactual sample should be used to explain output generated by a machine learning model without the need to perform additional computationally intensive tasks such as training separate machine learning models, of which the sole purpose is to generate counterfactual samples. Conventional systems do not have a way to evaluate and compare counterfactual samples and thus they rely on using these separate machine learning models (e.g., autoencoders) to generate counterfactual samples that are hoped to be representative of the training dataset.

In some aspects, a computing system may train, based on a training dataset, a machine learning model to classify a plurality of samples of a training dataset. Each sample of the plurality of samples may comprise a label indicating a correct classification for a corresponding sample. For example, the machine learning model may be trained to detect cyber security intrusions in a network and the training dataset may include network activity data and labels indicating whether a particular sample of network activity was a cyber security intrusion or not. A correct classification for a corresponding sample may mean that a machine learning model output a classification that matches a label of the sample.

The computing system may generate a plurality of counterfactual samples. Each counterfactual sample of the plurality of counterfactual samples may correspond to a first sample of the plurality of samples of the training dataset and each counterfactual sample may be classified, by the machine learning model, differently from the first sample. For example, the machine learning model may generate output indicating that the first sample should not be classified as a cyber security intrusion. In this example, each counterfactual sample may be a modified version of the first sample such that the machine learning model classifies each counterfactual sample as a cyber security intrusion.

The computing system may determine a distance score between the training dataset and a first counterfactual sample of the plurality of counterfactual samples. Based on determining that the distance between the training dataset and the first counterfactual sample is smaller than other distances corresponding to other counterfactual samples of the plurality of counterfactual samples, the computing system may generate a recommendation to use the first counterfactual sample. A distance score may include a maximum mean discrepancy. For example, the computing system may determine a maximum mean discrepancy for each counterfactual sample (e.g., by computing a distance score between the training dataset and each counterfactual sample). The computing system may determine the smallest maximum mean discrepancy and recommend to use the smallest maximum mean discrepancy's corresponding counterfactual sample as an explanation for the machine learning model's output for an input sample in question.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for using distance scores to evaluate quality levels of machine learning explanations, in accordance with one or more embodiments.

FIG. 2 shows an illustrative sample and counterfactual sample, in accordance with one or more embodiments.

FIG. 3 shows illustrative components for a system used to evaluate quality levels of machine learning explanations, in accordance with one or more embodiments.

FIG. 4 shows a flowchart of the steps involved in using distance scores to evaluate quality levels of machine learning explanations, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

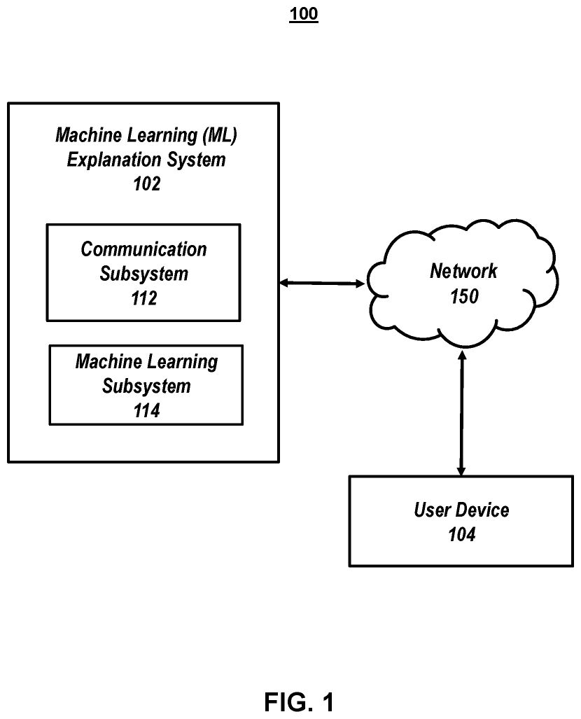

FIG. 1 shows an illustrative system 100 for using distance scores to evaluate quality levels of machine learning explanations, in accordance with one or more embodiments. The system 100 has numerous practical applications of machine learning models. For example, the system 100 can help evaluate explanations (e.g., counterfactual samples) for output generated by machine learning models that detect objects, determine whether a cyber security intrusion has occurred, detect the presence of cancer in medical data, approve or disapprove a user for a loan or other product offering, or a variety of other practical applications. The system 100 may determine whether a counterfactual sample should be used to explain output generated by a machine learning model by determining to what degree the counterfactual sample is representative of the training data used to train the machine learning model. If there are multiple counterfactual samples, the counterfactual sample that is most representative of the training data may be selected or recommended as an explanation for the machine learning model's output. The system 100 may determine to what degree a counterfactual sample is representative of the training data by determining a distance score (e.g., a maximum mean discrepancy) that indicates a distance between a first distribution corresponding to a particular sample of the training data and a second distribution corresponding to the counterfactual sample. The counterfactual sample with the lowest distance score may be selected as the best explanation for the machine learning model's output. Because the counterfactual samples can be effectively evaluated by the system 100, the system 100 can use less computationally intensive counterfactual samples generation techniques (e.g., instead of other less efficient techniques such as autoencoders) to create counterfactual samples. As such, the system 100 may determine explanations for the machine learning model more efficiently than conventional systems.

For example, FIG. 1 illustrates a machine learning (ML) explanation system 102. The ML explanation system 102 may include a communication subsystem 112 and a machine learning subsystem 114. The ML explanation system 102 may train (e.g., via the machine learning subsystem), based on a training dataset, a machine learning model to classify a plurality of samples of a training dataset. Each sample of the plurality of samples may comprise a label indicating a correct classification for a corresponding sample. A label may be a target output for a machine learning model. A label may be used by the machine learning model to learn. In one example, a label of 0 may indicate that a user should not be approved for a banking product (e.g., a loan, a credit card, etc.) while a label of 1 may indicate that a user should be approved for a banking product. The ML explanation system 102 may generate a plurality of counterfactual samples. Each counterfactual sample of the plurality of counterfactual samples may correspond to a first sample of the plurality of samples of the training dataset and each counterfactual sample may be classified, by the machine learning model, differently from the first sample.

The ML explanation system 102 (e.g., via the machine learning subsystem 114) may determine a distance score between the training dataset and a first counterfactual sample of the plurality of counterfactual samples. Based on determining that the distance between the training dataset and the first counterfactual sample is smaller than other distances corresponding to other counterfactual samples of the plurality of counterfactual samples, the ML explanation system 102 may generate a recommendation to use the first counterfactual sample as an explanation for output of the machine learning model. For example, the ML explanation system 102 may determine a maximum mean discrepancy for each counterfactual sample (e.g., a maximum mean discrepancy between the training dataset and each counterfactual sample). The ML explanation system 102 may determine the smallest maximum mean discrepancy and recommend using the smallest maximum mean discrepancy's corresponding counterfactual sample as an explanation for the machine learning model. For example, the ML explanation system 102 may send, via the computer network 150 (e.g., the Internet), the recommendation to the user device 104.

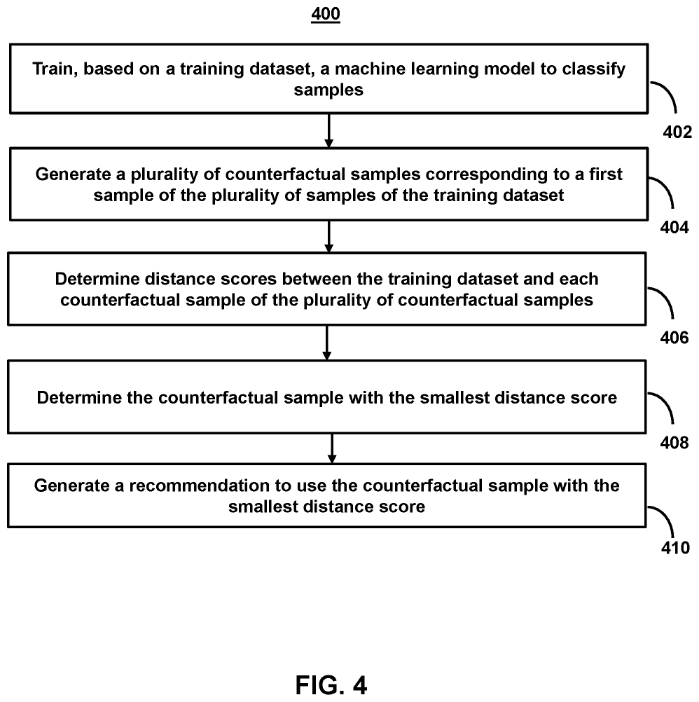

As referred to herein, a “counterfactual sample” may include any set of values that is designed to cause a machine learning model to generate output that is different from a corresponding sample. A counterfactual sample may include the feature values of an original sample with some of the feature values having been modified such that the output of the machine learning model changes in a relevant way. For example, the class output by the machine learning model for the counterfactual sample may be opposite of the class output for the original sample. Additionally, or alternatively, a counterfactual sample may cause the machine learning model to generate output that reaches a certain threshold (e.g., where the machine learning model outputs a probability that cancer is present reaches 10% or greater). A counterfactual sample of an original sample may try to minimize the amount of change to the feature values of the original sample while still changing the machine learning model's output. A counterfactual sample may be generated using a variety of techniques as described in more detail below and in connection with FIG. 4.

As referred to herein, a “feature” may be an individual measurable property or characteristic of a phenomenon. For example, features used to predict whether a user should be approved for a banking product may include income of the user, occupation of the user, credit history of the user, or zip code of the user.

As referred to herein, a “distance score” may include any metric used to determine whether a counterfactual sample is representative of data used to train a machine learning model (e.g., “in sample”). A distance or distance score may indicate how similar or close two elements are. A distance score may be an objective score that summarizes the relative difference between two objects in a problem domain. In some embodiments, the distance score may comprise a maximum mean discrepancy. In some embodiments, the distance score may comprise a Bhattacharyya distance, a total variation distance, a Hellinger distance, or an F-divergence score. In some embodiments, the distance score may comprise a point-to-point measurement (e.g., a distance score between a first sample and a counterfactual sample). In some embodiments, the distance score may be used to determine whether a counterfactual sample should be used to explain why a particular sample was classified as fraudulent. For example, the ML explanation system 102 may generate a distance score (e.g., using any of the distance score techniques described above) between a training dataset of credit card data and a counterfactual sample of credit card data that is classified as non-fraudulent (e.g., the counterfactual sample may correspond to a sample that was classified as fraudulent). Based on determining that the distance score is less than a threshold distance score (e.g., 0.3, 2, 15, etc.), the ML explanation system 102 may determine to use the counterfactual sample to explain why the first sample was classified as fraudulent. For example, the differences between the counterfactual sample and the first sample may indicate that the features corresponding to a location of the transaction and the transaction amount caused the machine learning model to classify the counterfactual sample as fraudulent, when the original sample was not classified as fraudulent.

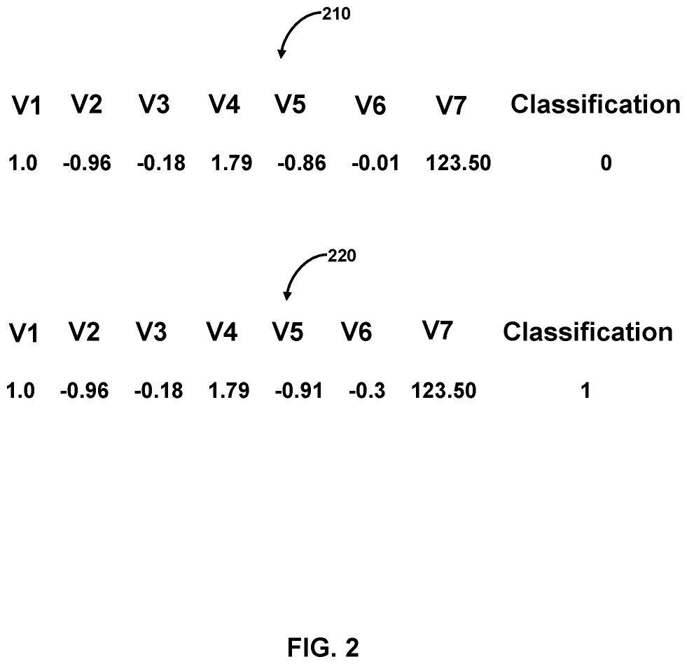

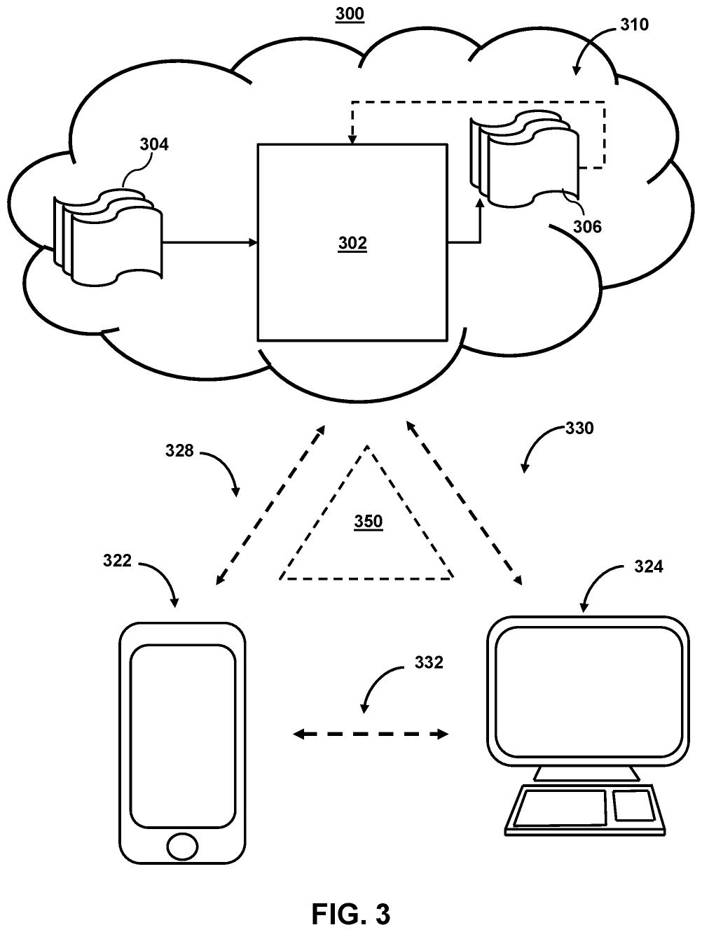

FIG. 2 shows an illustrative diagram for a sample 210 and a corresponding counterfactual sample 220, in accordance with one or more embodiments. The sample 210 is part of a dataset of credit card transactions that were classified as fraudulent or not fraudulent by a machine learning model. The sample 210 includes a set of feature values V1-V7 and a classification. The classification indicates that the sample 210 was classified as not fraudulent. The counterfactual sample 220 is the same as the sample 210 except that the feature values V5-V6 have been modified. As a result of the modification, the machine learning model classified the counterfactual sample 220 as fraudulent. Systems and methods described herein may use a distance score corresponding to the sample 210 and the counterfactual sample 220 to determine whether the counterfactual sample 220 is representative of the dataset of which sample 210 is a part. For example, the ML explanation system 102 may train, based on a training dataset, a machine learning model to classify a plurality of samples of a training dataset that comprises the sample 210. The ML explanation system 102 may generate a plurality of counterfactual samples that include the counterfactual sample 220. Each counterfactual sample of the plurality of counterfactual samples may correspond to the sample 210. Each counterfactual sample may be classified, by the machine learning model, differently from the sample 210 (e.g., each counterfactual sample may be classified as fraudulent). The ML explanation system 102 may determine a distance score between the sample 210 and the counterfactual sample 220. Based on determining that the distance between the sample 210 and the counterfactual sample 220 is smaller than other distances corresponding to other counterfactual samples of the plurality of counterfactual samples, the ML explanation system 102 may generate a recommendation to use the first counterfactual sample. For example, the ML explanation system 102 may determine a maximum mean discrepancy for each counterfactual sample. The ML explanation system 102 may determine that the counterfactual sample 220 had the smallest maximum mean discrepancy (e.g., as compared to other counterfactual samples) and may determine to use the counterfactual sample 220 as an explanation for why the machine learning model classified the sample 210 as not fraudulent. For example, the difference in feature values V5-V6 between the counterfactual sample 220 and the sample 210 explain why the machine learning model classified the sample 210 as not fraudulent instead of fraudulent. FIG. 3 shows illustrative components for a system used to evaluate counterfactual samples, in accordance with one or more embodiments. For example, FIG. 3 may show illustrative components for using distance scores to evaluate quality levels of machine learning explanations. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, mobile devices, and/or any device or system described in connection with FIGS. 1-2. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device, such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the ML explanation system 102 or the user device 104 described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., using distance scores to evaluate quality levels of machine learning explanations or counterfactual samples).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. A sample and a counterfactual sample that are input into the model (e.g., model 302) may be compared (e.g., using maximum mean discrepancy or a variety of other distance scores) to determine whether the counterfactual sample should be used to explain why the model generated the output corresponding to the sample.

System 300 also includes application programming interface (API) layer 350. API layer 350 may allow the system to generate summaries across different devices. In some embodiments, API layer 350 may be implemented on user device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

FIG. 4 shows a flowchart of the steps involved in using a distribution distance metric to evaluate quality levels of counterfactual samples, in accordance with one or more embodiments. For example, the system may use process 400 (e.g., as implemented on one or more system components described above) in order to evaluate or compare the quality of different counterfactual samples that may be used to explain how a classification was made by a machine learning model. Process 400 of FIG. 4 may represent the actions taken by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 402, the ML explanation system 102 may train a machine learning model to classify samples. The machine learning model may be trained based on a training dataset (e.g., as discussed above in connection with FIGS. 1-3). The training dataset may include a plurality of samples (e.g., instances) with each sample including a set of values. Each value may correspond to a feature. Each sample may include a label indicating a correct classification for the corresponding sample. For example, the training dataset may be used to train a machine learning model to recommend promotional offers to users. Each sample may include one or more values for features corresponding to users, including income level, geographic location (e.g., zip code), age, occupation, identification of recent purchases, or a variety of other features. Each sample may include a feature indicating a product or set of products (e.g., credit card offer, checking account offer, etc.) that was offered to the corresponding user. Each sample may include a label indicating whether a recommendation was taken by the corresponding user (e.g., whether the user accepted the offer of the credit card or other product).

At step 404, the ML explanation system 102 may generate a plurality of counterfactual samples corresponding to a first sample of the plurality of samples of the training dataset. Each counterfactual sample may be input into the machine learning model. Each counterfactual sample may be classified, by the machine learning model, differently from the first sample. A counterfactual sample corresponding to an original sample may include the same values as contained in the original sample except for one or more values that are modified to be different from the values of the original sample. Each counterfactual sample of the plurality of counterfactual samples may be classified differently from the first sample. For example, if the first sample was classified as fraudulent, the machine learning model may classify each counterfactual sample as non-fraudulent. The ML explanation system 102 may use a variety of counterfactual sample generation methods to generate the counterfactual samples including a variety of other methods in addition to those described below. By generating the counterfactual samples, the ML explanation system 102 may compare the counterfactual samples with a different sample (e.g., an original sample of the training dataset or a new sample not seen by the machine learning model before) and thus may be able to determine an explanation for why the machine learning model generated particular output. For example, as described in connection with FIG. 2 above, the counterfactual samples may be used to determine which features or values of features cause the machine learning model to classify a sample as fraud or not fraud.

For example, each sample in a dataset may include ten features. The counterfactual sample of an original sample (e.g., a first sample) in the dataset may be a copy of the original sample, except with a modified value replacing the original sample's value for the fifth feature in the sample. In this example, the modified value may cause the machine learning model to classify the counterfactual sample differently from the original sample. For example, the modified value may cause the machine learning model to recommend approving a loan for a user corresponding to the counterfactual sample, even though the loan was denied by the machine learning model for the original sample.

In some embodiments, the ML explanation system 102 may use a trainable variable to assist in generating counterfactual samples. The ML explanation system 102 may generate a trainable variable. The trainable variable, when added to a sample, may cause a machine learning model to classify the sample differently from the sample's corresponding label. For example, the ML explanation system 102 may train a logistic regression model on the training dataset. The ML explanation system 102 may generate, via the logistic regression model, the plurality of counterfactual samples.

In some embodiments, the ML explanation system 102 may use a variety of counterfactual generation techniques to generate counterfactual samples. For example, the ML explanation system 102 may use the multi-objective counterfactuals (MOC) method to generate the counterfactual samples. The MOC method may translate a search for counterfactual samples into a multi-objective optimization problem. As an additional example, the ML explanation system 102 may use the Deep Inversion for Synthesizing Counterfactuals (DISC) method to generate the counterfactual samples. The DISC method may use (a) stronger image priors, (b) incorporate a novel manifold consistency objective, and (c) adopt a progressive optimization strategy.

At 406, the ML explanation system 102 may determine one or more distance scores associated with the first sample. A distance score may indicate a distance between a first distribution corresponding to the first sample or training dataset and a second distribution corresponding to a counterfactual sample. A lower distance score may indicate that the two distributions are closer together or more similar, while a higher distance score may indicate that two distributions are more different. The ML explanation system 102 may determine a distance score for each counterfactual sample that was generated at 404. For example, if there are five counterfactual samples, the ML explanation system 102 may determine five distance scores: a first distance score between the first counterfactual sample and the training dataset, a second distance score between the second counterfactual sample and the training dataset, a third distance score between the third counterfactual sample and the training dataset, and so on. In some embodiments, the distance score may be a maximum mean discrepancy. Determining a maximum mean discrepancy may include inputting a sample into a reproducing kernel Hilbert space and based on inputting the sample into the reproducing kernel Hilbert space, generating the distance. In some embodiments, the distance score may be a Wasserstein distance or the distance score may be determined via the method of simulated moments. Through the use of a distance score, the ML explanation system 102 may be able to determine how a counterfactual sample compares with other counterfactual samples. For example, the ML explanation system 102 may be able to determine which counterfactual sample is most representative of the training dataset. This may enable the ML explanation system 102 to determine which counterfactual sample should be used to explain output generated by a machine learning model without the need to perform additional computationally intensive tasks such as training autoencoders to generate counterfactual samples.

The one or more distance scores may enable the ML explanation system 102 to assess if a counterfactual sample is “in sample” (e.g., that the counterfactual sample resembles the training data). Being in sample helps assure that the explanation is feasible. Feasible in this case means the customer could make the proposed changes to their application to get approved since there is training data with similar inputs close to the proposed counterfactual.

At step 408, the ML explanation system 102 may determine the counterfactual sample with the smallest distance score (e.g., smallest maximum mean discrepancy). The counterfactual sample that has a distribution closest to the distribution of the training dataset (e.g., the smallest distance score) may be selected to assist in explaining output (e.g., a classification) made by the machine learning model. For example, a counterfactual sample with the smallest distance score may indicate that if a user increased the user's income, the user would be approved for a loan. This may be because the only difference between the first sample that may have been classified as disapproved for a loan and the counterfactual sample which may have been classified as approved for the loan was that the income level was higher in the counterfactual sample. As an additional example, a counterfactual sample may indicate that a particular firewall feature should be changed to reduce the chances of a cybersecurity incident within the next year (e.g., as indicated by output of a machine learning model).

Additionally or alternatively, the ML explanation system 102 may determine which counterfactual samples (e.g., if any) have a corresponding distance that is lower than a threshold distance. Each counterfactual sample with a distance that is lower than the threshold distance may be recommended for use in explaining a classification of the machine learning model. For example, each counterfactual sample with a distance that is lower than the threshold distance may be recommended as an equally good explanation for a decision made by the machine learning model.

At step 410, the ML explanation system 102 may generate a recommendation to use the counterfactual sample with the smallest distance score. The recommendation may be generated based on determining that the distance between the first sample and the first counterfactual sample is smaller than other distances corresponding to other counterfactual samples of the plurality of counterfactual samples. For example, after determining the counterfactual sample with the smallest distance score at 408, the ML explanation system 102 may generate a recommendation to use the counterfactual sample to explain output (e.g., a classification) made by the machine learning model. The recommendation may be sent to the user device 104. The recommendation may be displayed via a user interface.

In some embodiments, the ML explanation system 102 may recommend using a counterfactual sample because its corresponding distance score satisfies a threshold. The ML explanation system 102 may determine that the distance between the training dataset and the first counterfactual sample is smaller than a threshold distance. Based on determining that the distance between the training dataset and the first counterfactual sample is smaller than a threshold distance, the ML explanation system 102 may generate a recommendation to use the first counterfactual sample to explain output generated by the machine learning model.

In some embodiments, the recommendation may indicate a technique that was used to generate the counterfactual sample. Each of the counterfactual samples may have been generated using different techniques and the technique used to generate the counterfactual sample with the smallest distance score (e.g., maximum mean discrepancy) may be determined to be the best technique for generating counterfactual samples. The recommendation may include a recommendation to use the technique to generate future counterfactual samples for the machine learning model. For example, if the counterfactual sample with the smallest distance score was generated using a log regression model, the recommendation may indicate that future counterfactual samples associated with the training dataset should be generated using the log regression model. As an additional example, if the counterfactual sample with the smallest distance score was generated using the technique of multi-objective counterfactuals or deep inversion for synthesizing counterfactuals, the recommendation may include an indication that multi-objective counterfactuals or deep inversion for synthesizing counterfactuals should be used to generate counterfactual samples for the machine learning model, the training dataset that the machine learning model was trained on, or future samples for which the machine learning model generates output.

In some embodiments, the recommendation may indicate an action for a user to perform so that the machine learning model will generate a particular output (e.g., classification). The action may be indicated by the difference between a counterfactual sample and the first sample described above. The ML explanation system 102 may determine a feature of the first counterfactual sample that is different from a corresponding feature of the first sample. The ML explanation system 102 may send, to a user device, a recommendation indicating an action to perform to change a classification result, wherein the action is determined based on the feature. For example, the ML explanation system 102 may determine that a user did not qualify for an interest rate (e.g., output of the machine learning model did not indicate the interest rate) because of the amount of debt (the feature in this example) of the user was higher than a threshold debt amount. In this example, the counterfactual sample may have had a lower debt amount and the machine learning model may have generated output indicating that a user that matched the counterfactual sample would have qualified for the interest rate. By doing so, the ML explanation system 102 may generate improved recommendations that allow for the determination of actions to take to change decision outcomes generated by machine learning models.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: training, based on a training dataset, a machine learning model to classify a plurality of samples of a training dataset, wherein each sample of the plurality of samples comprises a label indicating a correct classification for a corresponding sample; generating a plurality of counterfactual samples, wherein each counterfactual sample of the plurality of counterfactual samples corresponds to a first sample of the plurality of samples of the training dataset, and wherein each counterfactual sample is classified, by the machine learning model, differently from the first sample; determining a distance between the training dataset and a first counterfactual sample of the plurality of counterfactual samples; and based on determining that the distance between the training dataset and the first counterfactual sample is smaller than other distances corresponding to other counterfactual samples of the plurality of counterfactual samples, generating a recommendation to use the first counterfactual sample.
2. The method of the preceding embodiment, wherein generating a plurality of counterfactual samples comprises: generating a trainable variable, wherein the trainable variable, when added to the first sample, causes the machine learning model to classify the first sample differently from the first sample's corresponding label.
3. The method of any of the preceding embodiments, wherein determining the distance comprises: determining a maximum mean discrepancy between the training dataset and the first counterfactual sample and determining the distance based on the maximum mean discrepancy.
4. The method of any of the preceding embodiments, wherein the recommendation to use the first counterfactual sample comprises an indication of a technique used to generate the first counterfactual sample and a recommendation to use the technique to generate future counterfactual samples.
5. The method of any of the preceding embodiments, wherein generating the plurality of counterfactual samples comprises: generating the plurality of counterfactual samples using Multi-Objective Counterfactuals or Deep Inversion for Synthesizing Counterfactuals.
6. The method of any of the preceding embodiments, further comprising: determining a feature of the first counterfactual sample that is different from a corresponding feature of the first sample; and sending, to a user device, a recommendation indicating an action to perform to change a classification result, wherein the action is determined based on the feature.
7. The method of any of the preceding embodiments, further comprising: in response to generating a recommendation to use the first counterfactual sample, generating a user interface and displaying the recommendation in a user interface.
8. The method of any of the preceding embodiments, wherein generating a recommendation to use the first counterfactual sample further comprises: determining that the distance between the training dataset and the first counterfactual sample is smaller than a threshold distance; and based on determining that the distance between the training dataset and the first counterfactual sample is smaller than a threshold distance, generating a recommendation to use the first counterfactual sample.
9. The method of any of the preceding embodiments, wherein generating the plurality of counterfactual samples comprises: training a logistic regression model on the training dataset; and generating, via the logistic regression model, the plurality of counterfactual samples.
10. The method of any of the preceding embodiments, wherein determining the distance comprises: inputting the training dataset into a reproducing kernel Hilbert space; and based on inputting the training dataset into a reproducing kernel Hilbert space, generating the distance.
11. A tangible, non-transitory, machine-readable medium storing instructions that, when executed by a data processing apparatus, cause the data processing apparatus to perform operations comprising those of any of embodiments 1-10.
12. A system comprising one or more processors; and memory storing instructions that, when executed by the processors, cause the processors to effectuate operations comprising those of any of embodiments 1-10.
13. A system comprising means for performing any of embodiments 1-10.

What is claimed is:

1. A system for improving explanations for a machine learning model's classifications by using maximum mean discrepancy to evaluate quality levels of counterfactual samples, the system comprising:
one or more processors programmed with computer program instructions that, when executed by the one or more processors, cause operations comprising:
training, based on a training dataset, a machine learning model to classify samples, wherein the training dataset comprises a plurality of samples, each sample of the plurality of samples comprising a set of values corresponding to features and a label indicating a correct classification of each corresponding sample;
generating a plurality of counterfactual samples, wherein each counterfactual sample of the plurality of counterfactual samples corresponds to a first sample of the plurality of samples of the training dataset, and wherein each counterfactual sample is classified, by the machine learning model, differently from the first sample;
determining a distance between the training dataset and a first counterfactual sample of the plurality of counterfactual samples, wherein the distance comprises a maximum mean discrepancy between the training dataset and the first counterfactual sample; and
based on determining that the distance between the training dataset and the first counterfactual sample is smaller than other distances corresponding to other counterfactual samples of the plurality of counterfactual samples, generating a recommendation to use the first counterfactual sample.

2. A method for evaluating quality levels of counterfactual samples, the method comprising:
training, based on a training dataset, a machine learning model to classify a plurality of samples of a training dataset, wherein each sample of the plurality of samples comprises a label indicating a correct classification for a corresponding sample;
generating a plurality of counterfactual samples, wherein each counterfactual sample of the plurality of counterfactual samples corresponds to a first sample of the plurality of samples of the training dataset, and wherein each counterfactual sample is classified, by the machine learning model, differently from the first sample;
determining a distance between the training dataset and a first counterfactual sample of the plurality of counterfactual samples; and
based on determining that the distance between the training dataset and the first counterfactual sample is smaller than other distances corresponding to other counterfactual samples of the plurality of counterfactual samples, generating a recommendation to use the first counterfactual sample.

3. The method of claim 2, wherein generating a plurality of counterfactual samples comprises:
generating a trainable variable, wherein the trainable variable, when added to the first sample, causes the machine learning model to classify the first sample differently from the first sample's corresponding label.

4. The method of claim 2, wherein determining the distance comprises:
determining a maximum mean discrepancy between the training dataset and the first counterfactual sample; and
determining the distance based on the maximum mean discrepancy.

5. The method of claim 2, wherein the recommendation to use the first counterfactual sample comprises an indication of a technique used to generate the first counterfactual sample and a recommendation to use the technique to generate future counterfactual samples.

6. The method of claim 2, wherein generating the plurality of counterfactual samples comprises:
generating the plurality of counterfactual samples using Multi-Objective Counterfactuals or Deep Inversion for Synthesizing Counterfactuals.

7. The method of claim 2, further comprising:
determining a feature of the first counterfactual sample that is different from a corresponding feature of the first sample; and
sending, to a user device, a recommendation indicating an action to perform to change a classification result, wherein the action is determined based on the feature.

8. The method of claim 2, further comprising:
in response to generating a recommendation to use the first counterfactual sample, generating a user interface; and
displaying the recommendation in a user interface.

9. The method of claim 2, wherein generating a recommendation to use the first counterfactual sample further comprises:
determining that the distance between the training dataset and the first counterfactual sample is smaller than a threshold distance; and
based on determining that the distance between the training dataset and the first counterfactual sample is smaller than a threshold distance, generating a recommendation to use the first counterfactual sample.

10. The method of claim 2, wherein generating the plurality of counterfactual samples comprises:
training a logistic regression model on the training dataset; and
generating, via the logistic regression model, the plurality of counterfactual samples.

11. The method of claim 2, wherein determining the distance comprises:
inputting the training dataset into a reproducing kernel Hilbert space; and
based on inputting the training dataset into a reproducing kernel Hilbert space, generating the distance.

12. A non-transitory, computer-readable medium comprising instructions that, when executed by one or more processors, causes operations comprising:
training, based on a training dataset, a machine learning model to classify a plurality of samples of a training dataset, wherein each sample of the plurality of samples comprises a label indicating a correct classification for a corresponding sample;
generating a plurality of counterfactual samples, wherein each counterfactual sample of the plurality of counterfactual samples corresponds to a first sample of the plurality of samples of the training dataset, and wherein each counterfactual sample is classified, by the machine learning model, differently from the first sample;
determining a distance between the training dataset and a first counterfactual sample of the plurality of counterfactual samples; and
based on determining that the distance between the training dataset and the first counterfactual sample is smaller than other distances corresponding to other counterfactual samples of the plurality of counterfactual samples, generating a recommendation to use the first counterfactual sample.

13. The medium of claim 12, wherein generating a plurality of counterfactual samples comprises:
generating a trainable variable, wherein the trainable variable, when added to the first sample, causes the machine learning model to classify the first sample differently from the first sample's corresponding label.

14. The medium of claim 12, wherein determining the distance comprises:
determining a maximum mean discrepancy between the training dataset and the first counterfactual sample; and
determining the distance based on the maximum mean discrepancy.

15. The medium of claim 12, wherein the recommendation to use the first counterfactual sample comprises an indication of a technique used to generate the first counterfactual sample and a recommendation to use the technique to generate future counterfactual samples.

16. The medium of claim 12, wherein generating the plurality of counterfactual samples comprises:
generating the plurality of counterfactual samples using Multi-Objective Counterfactuals or Deep Inversion for Synthesizing Counterfactuals.

17. The medium of claim 12, wherein the instructions, when executed, cause operations further comprising:
determining a feature of the first counterfactual sample that is different from a corresponding feature of the first sample; and
sending, to a user device, a recommendation indicating an action to perform to change a classification result, wherein the action is determined based on the feature.

18. The medium of claim 12, wherein the instructions, when executed, cause operations further comprising:
in response to generating a recommendation to use the first counterfactual sample, generating a user interface; and
displaying the recommendation in a user interface.

19. The medium of claim 12, wherein generating a recommendation to use the first counterfactual sample further comprises:
determining that the distance between the training dataset and the first counterfactual sample is smaller than a threshold distance; and
based on determining that the distance between the training dataset and the first counterfactual sample is smaller than a threshold distance, generating a recommendation to use the first counterfactual sample.

20. The medium of claim 12, wherein generating the plurality of counterfactual samples comprises:
training a logistic regression model on the training dataset; and
generating, via the logistic regression model, the plurality of counterfactual samples.
